(19) United States
(12) Patent Application Publication
(10) Pub. No.: US 2011/0093437 A1
(43) Pub. Date: Apr. 21, 2011

(54) METHOD AND SYSTEM FOR GENERATING A SPACE-EFFICIENT SNAPSHOT OR SNAPCLONE OF LOGICAL DISKS

(76) Inventor: Kishore Kaniyar SAMPATHKUMAR, Bangalore (IN)

(21) Appl. No.: 12/688,913

(22) Filed: Jan. 18, 2010

(30) Foreign Application Priority Data
Oct. 15, 2009 (IN) 2511/CHE/2009

(51) Int. Cl. G06F 17/30

(52) U.S. Cl. 707/649; 707/E17.005

(57) ABSTRACT

A method and system for generating a snapshot of one or more logical disks storing file-system data associated with a file system are disclosed. In one embodiment, the file system is quiesced upon a receipt of a command to generate the snapshot of the logical disks, where the snapshot is a copy of the logical disks at a point in time. Then, a disk usage of the logical disks at the point in time is determined. Further, a sharing bitmap associated with the snapshot is generated based on the disk usage, where the sharing bitmap is configured to indicate sharing of the file-system data with the logical disks and a predecessor snapshot immediately preceding the snapshot. Moreover, the file system is unquiesced.

### RELATED APPLICATIONS

Benefit is claimed under 35 U.S.C. 119(a)-(d) to Foreign application Serial No. 2511/CHE/2009 entitled “METHOD AND SYSTEM FOR GENERATING A SPACE-EFFICIENT SNAPSHOT OR SNAPCLONE OF LOGICAL DISKS” by Hewlett-Packard Development Company, L.P., filed on Oct. 15, 2009, which is herein incorporated in its entirety by reference for all purposes

### BACKGROUND

In computer file systems, a snapshot is a copy of file-system data, such as a set of files and directories, stored in one or more logical disks as they were at a particular point in the past. When a snapshot operation is executed, no data may be physically copied from the logical disks to the snapshot. Instead, one or more mapping structures, such as a sharing bitmap, may be generated to represent a sharing relationship established for a sharing tree which may include the snapshot, other snapshots, and the logical disks. For example, share bits in the sharing bitmap may be configured to represent the sharing relationship for the sharing tree. Further, a snapclone may be formed by physically copying the content of the logical disks to the snapshot and severing the sharing relationship between the snapclone and the rest of the sharing tree. As a result, an independent point-in-time copy of the logical disks may be created.

### BRIEF DESCRIPTION OF THE DRAWINGS

Embodiments of the present invention are illustrated by way of examples and not limited to the figures of the accompanying drawings, in which like references indicate similar elements and in which:

FIGS. 1A-1C illustrate schematic diagrams illustrating a write operation directed to a snapshot.

FIGS. 2A-2F illustrate schematic diagrams illustrating a snap clone operation.

FIG. 3 illustrates a network file system with an exemplary file server for generating a snapshot of one or more logical disks containing file-system data, according to one embodiment;

FIG. 4 illustrates an exemplary computer implemented process diagram for a method of generating a snapshot of one or more logical disks containing file-system data, according to one embodiment;

FIG. 5 illustrates a schematic diagram depicting an exemplary process for generating a data validity bitmap and a sharing bitmap of a snapshot, according to one embodiment;

FIGS. 6A-6C illustrate schematic diagrams of an exemplary process for maintaining data consistency of logical segments in logical disks, according to one embodiment;

FIGS. 7A and 7B illustrate schematic diagrams of exemplary read operations directed to a snapshot, according to one embodiment;

FIGS. 8A-8C illustrate schematic diagrams of an exemplary write operation directed to a snapshot, according to one embodiment;

FIGS. 9A-9C illustrate schematic diagrams of an exemplary snapclone operation, according to one embodiment; and

FIG. 10 shows an example of a suitable computing system environment for implementing embodiments of the present subject matter.

Other features of the present embodiments will be apparent from the accompanying drawings and from the detailed description that follow.

### DETAILED DESCRIPTION

A method and system for generating a snapshot of one or more logical disks is disclosed. According to various embodiments of the present invention, the knowledge of unused or free space in file system data at the time of creation of its snapshot or snapclone may be used to reduce time and disk space employed for the creation of the snapshot or snapclone. This may be achieved by determining the disk usage of the file system data, generating meta-data representing the disk usage, and selectively copying valid point in time data sans the unused or free space during a write operation or snapclone operation associated with the snapshot.

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

Throughout the document, the term “valid data” is used to indicate “actual data,” “meta-data,” or “used space,” whereas the term “invalid data” is used to indicate “free space” or “unused space.”

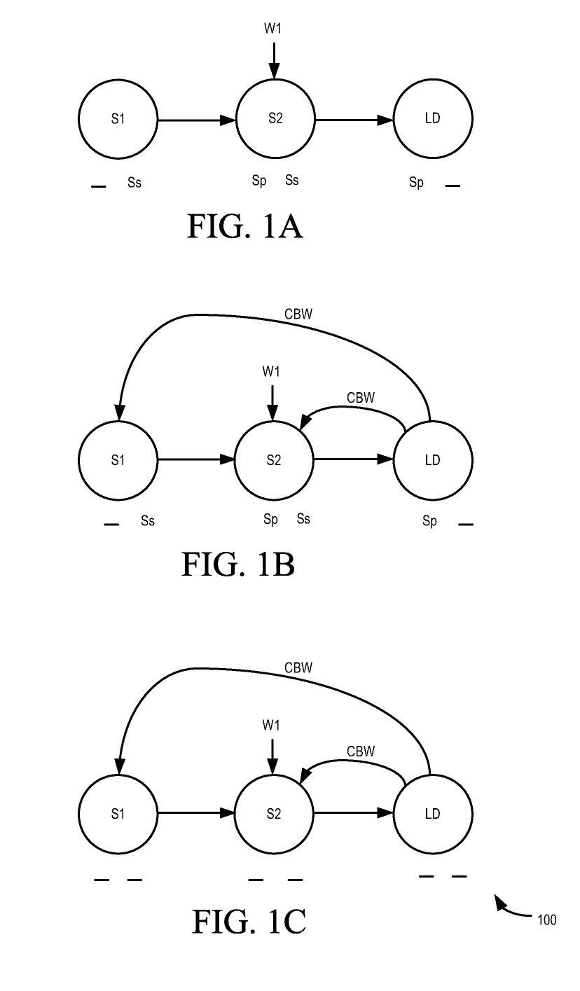

FIGS. 1A-1C illustrate schematic diagrams illustrating a write operation directed to a snapshot. FIG. 1A illustrates a write operation (W1) directed to a second snapshot (S2) of a logical segment in a logical disk (LD), where the logical segment may be a unit building block of LD. In FIG. 1A, the logical segment is shared among a first snapshot (S1), S2, and LD, as represented by share bits for the logical segment. That is, a predecessor share bit (Sp) of S1 is cleared to indicate that S1 of the logical segment is the first snapshot of the logical segment. A successor share bit (Ss) of S1 as well as a predecessor share bit (Sp) of S2 is set to indicate that S1 is sharing the logical segment with S2. Further, a successor share bit (Ss) of S2 as well as a predecessor share bit (Sp) of LD is set to indicate that S2 is sharing the logical segment with LD. A successor share bit (Ss) of LD is cleared to indicate that there is no successor to LD.

As the write operation (W1) to S2 of the logical segment may bring a change to the sharing relationship between S1, S2, and LD with respect to the logical segment, some steps may be taken prior to the write operation (W1). Moreover, the share bits associated with S1, S2, and LD with respect to the logical segment may be reconfigured to reflect the change in the sharing relationship brought by the write operation (W1). Thus, in FIG. 1B, the logical segment in LD may be physically copied to S2 prior to the write operation (W1) since S2 does not actually store the data in the logical segment. That is, prior to the triggering of the write operation (W1) as in FIG. 1A, S2 has been sharing the logical segment with LD, so S2, using its share bits, points to LD to represent that the logical segment in LD is identical to a point in time copy of the logical segment, i.e., S2. However, this relationship is about to change due to the write operation (W1) to S2, so is their sharing relationship.

During this so called a copy before write (CBW) operation, one or more physical segments corresponding to the logical segment of LD are allocated to S2. Then, the data in the logical segment is copied to the physical segments of S2. Further, since the impending write operation (W1) to S2 may incur change in the data shared between S1 and S2, the CBW operation may need to be performed to S1 as well.

Then, in FIG. 1C, the sharing relationship between 51, S2, and LD is reconfigured by setting their respective share bits. Thus, the Ss of S1 and the Sp of S2 are cleared to sever the sharing relationship between S1 and S2. Likewise, the Ss of S2 and the Sp of LD are cleared to sever the sharing relationship between S2 and LD. The write operation (W1) may follow the reconfiguration of share bits. Alternatively, the write operation (W1) may be performed after the CBW operation.

Although the snapshot operation in general save storage space by utilizing a sharing relationship among the snapshots and LD, the write operation (W1) performed to a snapshot, as illustrated in FIGS. 1A-1C, or to LD may copy invalid data as well as valid ones, thus taking up extra storage space as well as additional time.

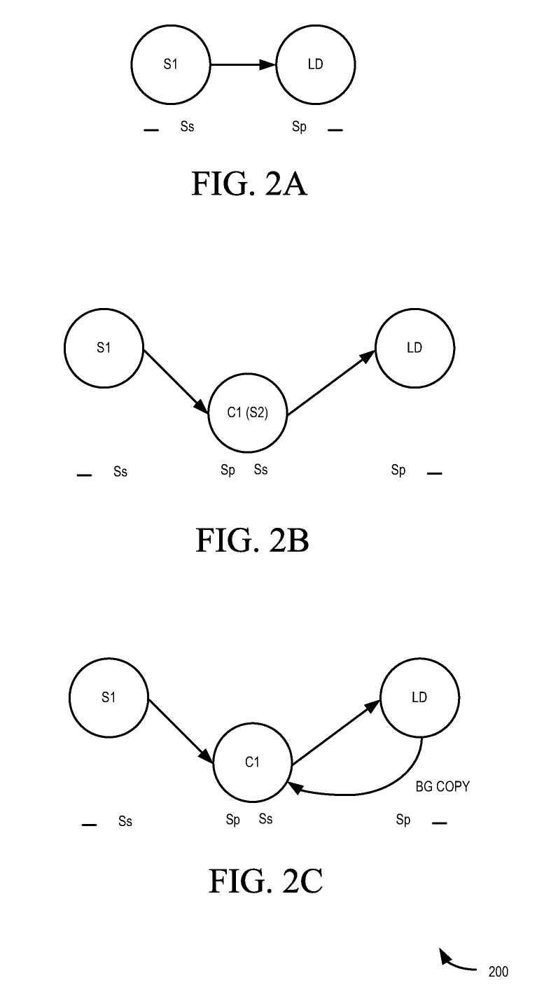

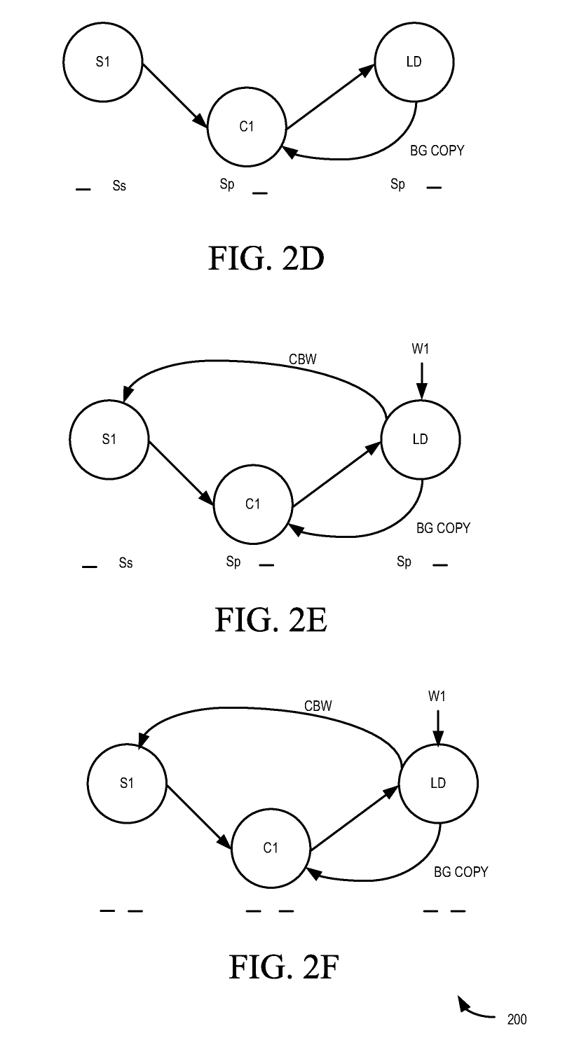

FIGS. 2A-2F illustrate schematic diagrams illustrating a snap clone operation. FIG. 2A illustrates a sharing relationship between a first snapshot (S1) and a logical disk (LD). It is noted that share bits representing the sharing relationship in FIG. 2A are not for a single logical segment as in FIGS. 1A-1C but rather the entirety of the logical disk which may contain numerous logical segments. As soon as a snapclone operation is initiated in FIG. 2B, a background copy (BG COPY) operation is triggered in FIG. 2C. During this BG COPY operation, physical segments corresponding to the entire logical segments of LD are allocated to a snapclone (C1). Then, the data in LD are copied to the physical segments allocated to C1.

Then, in FIG. 2D, the sharing relationship between S1, C1, and LD is reconfigured by setting their respective share bits. Thus, the Ss of C1 is cleared since C1 no longer depends on LD. In FIG. 2E, as a write operation (W1) to LD is triggered similar to the snapshot write operation illustrated in FIGS. 1A-1C, a CBW operation is performed for S1 rather than to C1. This is due to the fact that S1 needs to preserve its point in time copy of LD by physically backing up the data in LD to S1 before LD goes through with the write operation (W1) and that C1 may no longer be in the sharing relationship with S1 or LD after the write operation (W1). Then in FIG. 2F, the sharing relationship between S1, C1, and LD is reconfigured by setting their respective share bits. Thus, the Ss of S1 and the Sp of C1 are cleared to sever the sharing relationship between S1 and C1. Likewise, the Ss of C1 and the Sp of LD are cleared to sever the sharing relationship between C1 and LD. As a result, a snapclone, which is a point in time independent copy of LD, is formed.

However, during the snapclone operation illustrated in FIGS. 2A-2F, the BG COPY operation may copy invalid data as well as valid ones from LD to C1, thus taking up extra storage space as well as additional time.

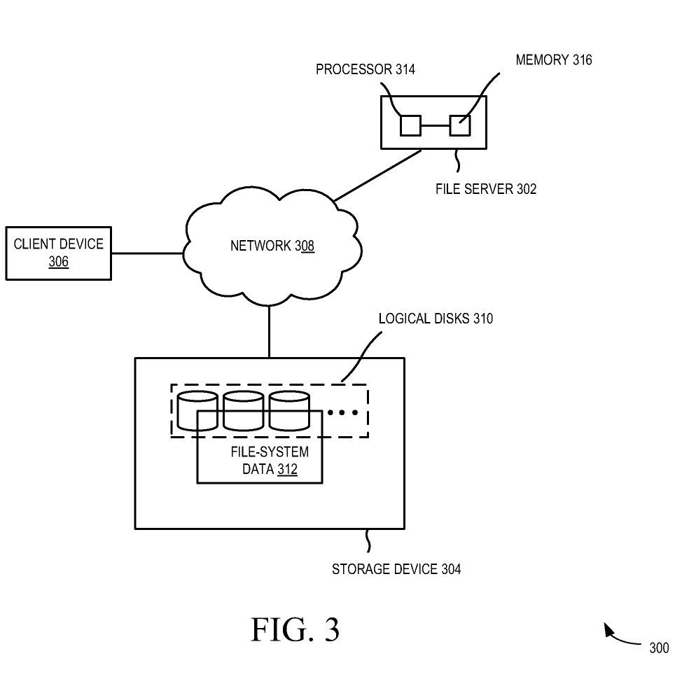

FIG. 3 illustrates a network file system 300 with an exemplary file server 302 for generating a snapshot of one or more logical disks 310 containing file-system data 312, according to one embodiment. In FIG. 3, the network file system 300 includes the file server 302 coupled to a storage device 304 and a client device 306 through a network 308. The storage device 304 includes the logical disks 310 which may store the file-system data 312, such as files, directories, and so on. In an example operation, the network file system 300 may be based on a computer file system or protocol, such as Linux® ext2/ext3, Windows® New Technology File System (NTFS), and the like, that supports sharing of the file-system data 312 serviced by the file server 302 over the network 308. The file server 302 may be used to provide a shared storage of the file-system data 312 that may be accessed by the client device 306.

In another example operation, a snapshot of a portion or entirety of the file-system data 312 may be generated upon a receipt of a command for initiating the snapshot coming from the client device 306 or according to an internal schedule. For the logical disks 310 containing the file-system data 312, creation of the snapshot may be preceded by orchestration with the file server 302. This may be needed to ensure consistency and integrity of the snapshot, wherein the snapshot is a point in time copy of the logical disks 310. Currently, the snapshot operation may not be equipped with a mechanism to exploit the context of this interaction with the file server 302 to optimize time and memory space that goes into forming the snapshot.

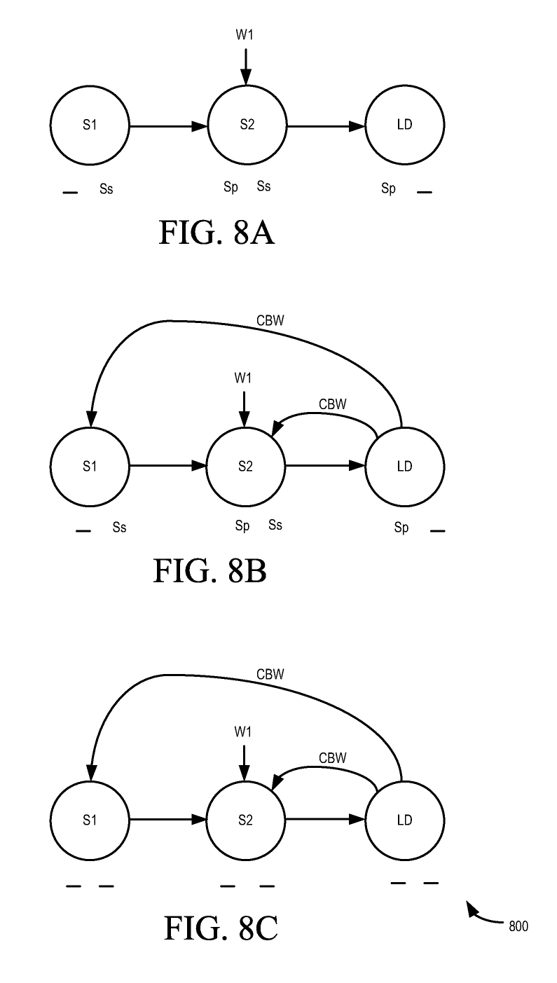

That is, the file-system data 312 residing in the logical disks 310 may have substantial amount of free or unused space. Since, the disk usage of the logical disks 310 storing the file-system data 312 may be unchecked during the existing snapshot operation, invalid data, for example, free or unused space, in the file-system data 312 may be treated same as valid data during the snapshot operation. Thus, in one embodiment, a sharing bitmap associated with the snapshot may include information about the disk usage of the logical disks 310 at the time the snapshot is created. The sharing bitmap may then be utilized to reduce time and disk space to accommodate a write operation associated with the snapshot, as will be illustrated in detail in FIGS. 8A-8C.

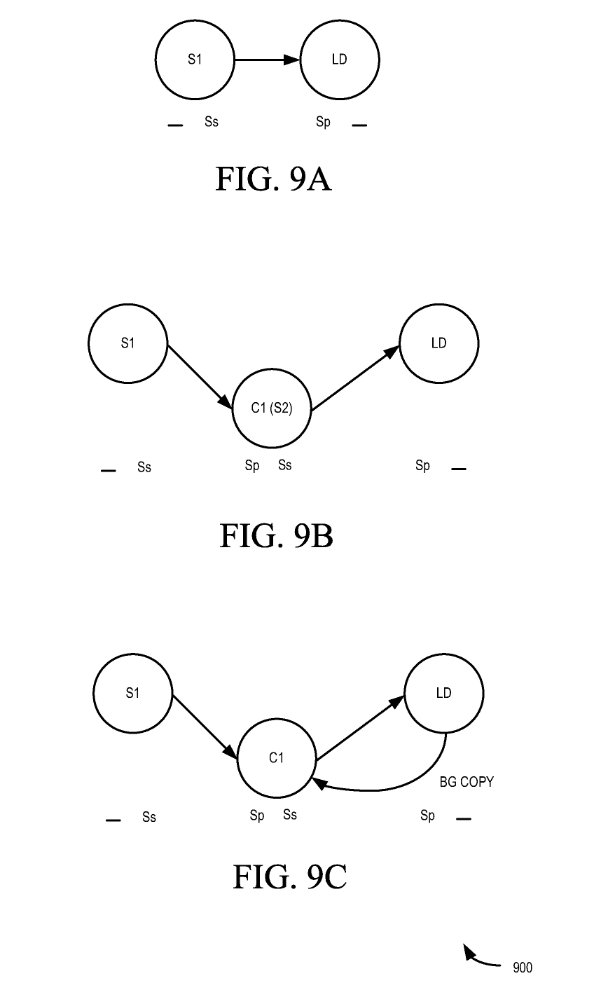

Further, an existing snapclone operation on the logical disks may include a process of physically copying both invalid and valid point in time data from the logical disks 310 at a point in time to generate an independent physical copy of the logical disks 310. Thus, in one embodiment, the time and/or space taken to perform the snapclone operation of the logical disks 310 may be reduced if the disk usage of the file-system data 312 is taken into account during the snapclone operation, as will be illustrated in detail in FIGS. 9A-9C.This way, the file-system data 312 may be discriminately copied during the snapclone operation of the logical disks 310.

Accordingly, in one embodiment, the file server 302 includes a processor 314 and a memory 316 configured for storing a set of instructions for generating a snapshot of the logical disks 310 containing the file-system data 312. The set of instructions, when executed by the processor 314, may quiesce or freeze the network file system 300 upon a receipt of a command to generate the snapshot of the logical disks 310, where the snapshot is a copy of the logical disks 310 at a point in time. Then, a disk usage of the logical disks 310 at the point in time may be determined. In addition, a sharing bitmap associated with the snapshot may be generated based on the disk usage. Further, upon the completion of the snapshot process, the network file system 300 may become unquiesced or active again.

Although the snapshot or snapclone method described in various embodiments of the present invention is described in terms of the network file system 300 in FIG. 3, it is noted that the methods may be operable in other environments besides the network file system 300. For example, the snapshot or snapclone method may be implemented in a personal computer, a laptop, a mobile device, a netbook, and the like to take snapshots of the file-system data 312 stored in the devices.

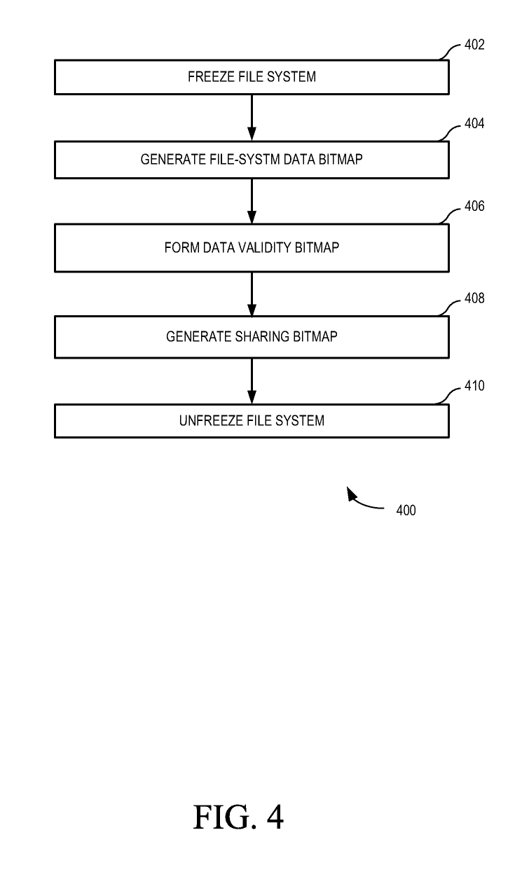

FIG. 4 illustrates an exemplary computer implemented process diagram 400 for a method of generating a snapshot of one or more logical disks containing file-system data, according to one embodiment. It is appreciated that the method may be implemented to the network file system 300 of FIG. 3 or other file system type. In step 402, a file-system quiescing or freezing operation is performed, where the file-system quiescing operation puts the file-system into a temporarily inactive or inhibited state. For example, when the snapshot for the file-system data stored in the logical disks is triggered, the file-system quiescing operation may be initiated. Then, the file system quiescing operation may take effect when ongoing input/output (I/O) operations are completed.

In step 404, a file-system data bitmap is generated by determining the disk usage of the logical disks storing the file-system data. By accessing meta-data of the file-system data which indicate the disk usage of the file-system data, the file-system data bitmap may configure its flag bits to indicate the disk usage per each block of the file-system data. For example, if the file-system data is stored in ten blocks which include five blocks storing valid data and five blocks containing free space, the flag bits for the first five blocks in the file-system data bitmap may be set (to ‘1’s), whereas the flag bits for the latter five blocks may remain clear (to ‘0’s).

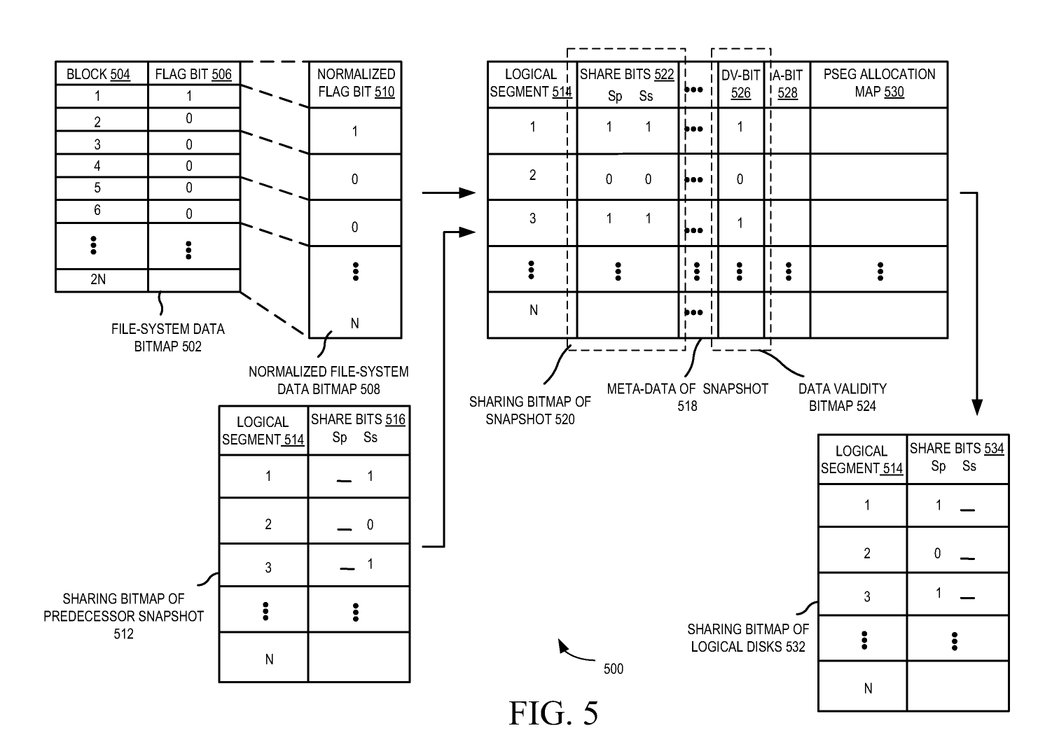

In step 406, a data validity bitmap is formed based on the file-system data bitmap as well as sharing bits of a predecessor snapshot which immediately precedes the snapshot of the logical disks currently being generated. As will be illustrated in detail in FIG. 5, the data validity bitmap is configured to indicate the validity of data stored or contained in the logical disks by using its data validity bits, where each data validity bit is allocated for each logical segment in the logical disks. For example, a data validity bit for a logical segment storing valid data, such as meta-data or actual data of the file system, may be set (to ‘1’), whereas a data validity bit for a logical segment containing invalid data, such as free-space, may be cleared (to ‘0’). It is noted that, once the data validity bit is cleared for the logical segment, the data validity bit may be set when new data is written to the snapshot of the logical segment.

In step 408, a sharing bitmap for the snapshot is generated based on the data validity bitmap. The sharing bitmap may include a set of share bits, with each predecessor share bit of the current snapshot indicating a sharing relationship between the predecessor snapshot and the current snapshot. A successor share bit of the current snapshot may indicate a sharing relationship between the current snapshot and a successor. The successor may be a successor snapshot or the logical disks. In one embodiment, successor sharing bits of the current snapshot allocated for logical segments containing free space may be cleared. In addition, predecessor share bits of the successor allocated for the logical segment may be cleared as well. This way, invalid data or free space may not be shared across the snapshots and the logical disks.

Thus, in a subsequent write operation to the snapshot, copying of the logical segments to the snapshot before the write operation may be skipped since the logical segments contain invalid data. Accordingly, the selective copying of valid data to the snapshot may reduce time and disk space necessary for the write operation to the snapshot. In addition, in a snapclone operation, which forms an independent disk out of the snapshot, more time and space may be saved since the snapclone operation involves physical copying of the entire logical disks. In step 410, the file system is turned back on or unquiesced as the snapshot or snapclone operation is completed.

FIG. 5 illustrates a schematic diagram 500 depicting an exemplary process for generating a data validity bitmap 524 and a sharing bitmap of a snapshot 520, according to one embodiment. In FIG. 5, a file-system data bitmap 502 may be generated based on the disk usage of logical disks. The validity or nature of data in each block 504 may be indicated by its respective flag bit 506. For instance, if the flag bit for a particular block of the file-system data is set (‘1’), the block is determined to store valid data, such as meta-data or actual data. However, if the flag bit for another block is clear (‘0’), the block is determined to contain invalid data, such as free-space.

In one embodiment, the file-system data bitmap 502 may be generated by creating multiple flag bits equal in number with blocks, such as data blocks or meta-data blocks, in the file-system data. Then, the file-system data bitmap 502 may be initialized by assigning ‘0’s to all the flag bits. Further, those flag bits for the meta-data blocks may be assigned with ‘1’s. For instance, in Linux ext2 file system, the meta-data blocks which may include file system control information, such as the superblock and file system descriptors, as well as other meta-data types, such as the block bitmap, inode bitmap, inode table, and the like, may be assigned with ‘1’s. Then, the remainder of the flag bits in the file-system data bitmap 502 may be configured to indicate validity of the data blocks. For example, in Linux ext2 file system, the block bitmap may be read to determine the validity of each data block of the file-system data. Based on the determination, some of the flag bits may be set (‘1’) if their corresponding data blocks store valid data. If other data blocks store free space, their corresponding flag bits may remain clear (‘0’).

Once the file-system data bitmap 502 is generated and configured based on the disk usage of the file-system data, the file-system data bitmap 502 may be normalized to the granularity of the sharing bitmap of the snapshot 520. The normalization step may be performed as the block size of the file-system data may be different from the segment size of the logical disks.

In one example implementation, if the block size of the file-system data is smaller than the segment size of the logical disks, one or more flag bits of the file-system data bitmap 502 may be combined to form each normalized flag bit 510 in a normalized file-system data bitmap 508. For example, as illustrated in FIG. 5, if two blocks of the file-system data are equal in size with a single logical segment, corresponding two flag bits of the file-system data bitmap 502 may be combined to form a single normalized flag bit in the normalized file-system data bitmap 508. Accordingly, flag bits for block 1 and block 2 in the file-system data bitmap 502 may be combined to generate the flag bit for block 1 in the normalized file-system data bitmap 508. Since the flag bits for the two blocks are ‘1’ and ‘0,’ the normalized flag bit becomes ‘1,’ which indicates the presence of valid data. Accordingly, flag bits for block 3 and block 4 as well as flag bits for block 5 and block 6 may be combined to generate their respective normalized flag bits.

In another example implementation, if the block size of the file-system data is larger than the segment size of the logical disks, each flag bit may be replicated to its corresponding flag bits in the normalized file-system data bitmap 508. For example, if a single block of the file-system data is twice as big as the segment size of the logical disks, each flag bit of the file-system data may be duplicated to its corresponding flag bits in the normalized file-system data bitmap 508.

In one embodiment, basing on the normalized file-system data bitmap 508 and a sharing bitmap of a predecessor snapshot 512, the data validity bitmap 524 may be created. It is noted that, the predecessor snapshot is a point in time copy of the logical disks which immediately precedes the current snapshot. It is also noted that, the sharing bitmap of the predecessor snapshot 512 may indicate sharing relationship of the predecessor snapshot with the current snapshot and with its own predecessor snapshot, if any. For example, in the sharing bitmap of the predecessor snapshot 512, successor share bits (Ss) of the predecessor snapshot 512 are configured as ‘1,’ ‘0,’ and ‘1,’ respectively, indicating that the predecessor snapshot shares logical segment 1 and logical segment 3 with the current snapshot. Additionally, all the predecessor share bits (Sp) of the predecessor snapshot are clear, thus indicating that there is no sharing relationship between the predecessor snapshot and its predecessor, if any.

As illustrated in FIG. 5, the data validity bitmap 524 includes multiple data validity bits, where each data validity bit 526 (DV-bit) may indicate the validity of data stored in each logical segment of the logical disks. The data validity bitmap 524 may be initialized by assigning ‘0’s to the data validity bits. Subsequently, the data validity bitmap 524 may be configured based on the normalized file-system data bitmap 508 and the sharing bitmap of the predecessor snapshot 512.

In one embodiment, a data validity bit of the snapshot allocated for a logical segment may be set (‘1’) when its corresponding flag bit in the normalized file-system data bitmap 508 is configured as ‘1’. The setting of the data validity bit may indicate that the logical segment stores valid data. Since the snapshot for the logical segment stores valid data, both the predecessor share bit (Sp) and the successor share bit (Ss) may be set (‘1’) as in the case of logical segment 1 of the sharing bitmap of the snapshot 520.

In one embodiment, a data validity bit of the snapshot allocated for a logical segment may be cleared (‘0’) when a corresponding flag bit in the normalized file-system data bitmap 508 is clear (‘0’) and a corresponding successor share bit of the predecessor snapshot allocated for the logical segment is configured as ‘0’. That is, as the corresponding block(s) in the file-system data contains free space at the time of the snapshot, and the current snapshot of the logical segment does not have a sharing relationship with its predecessor, the snapshot of the logical segment may be concluded to contain invalid data. Since the snapshot for the logical segment contains invalid data, a successor share bit of the snapshot for the logical segment may be cleared (‘0’) as in the case of logical segment 2 in the sharing bitmap of the snapshot 520. In addition, a predecessor share bit of a successor, such as the subsequent snapshot or the logical disks, for the logical segment may be cleared as well. In FIG. 5, the predecessor share bit (Sp) for logical segment 2 in the logical disks is cleared.

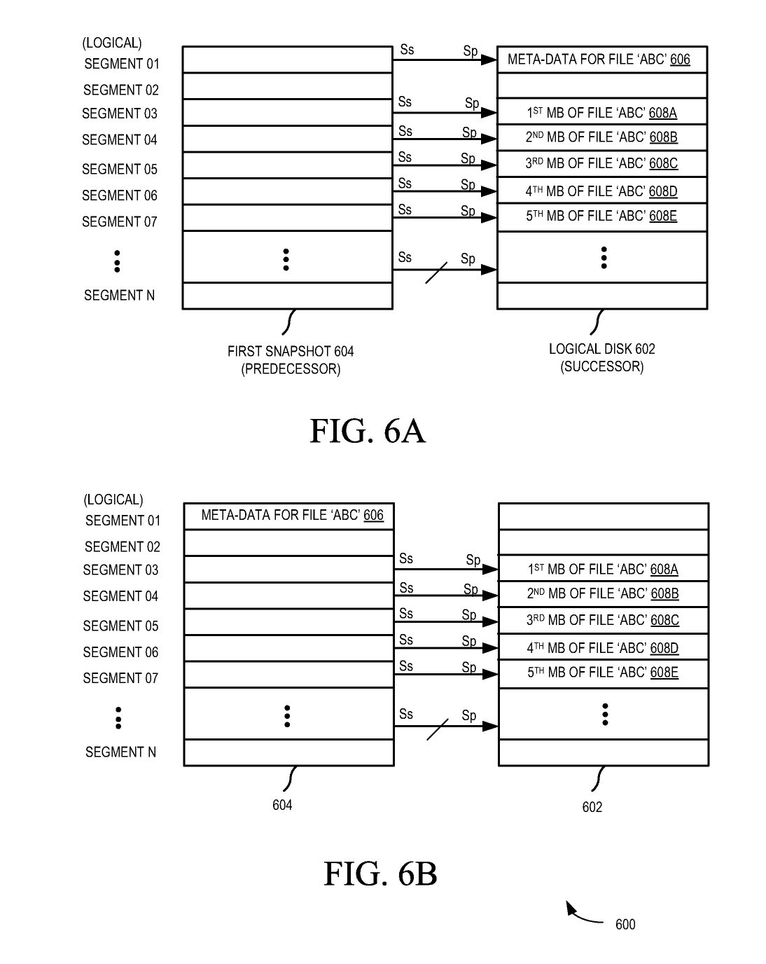

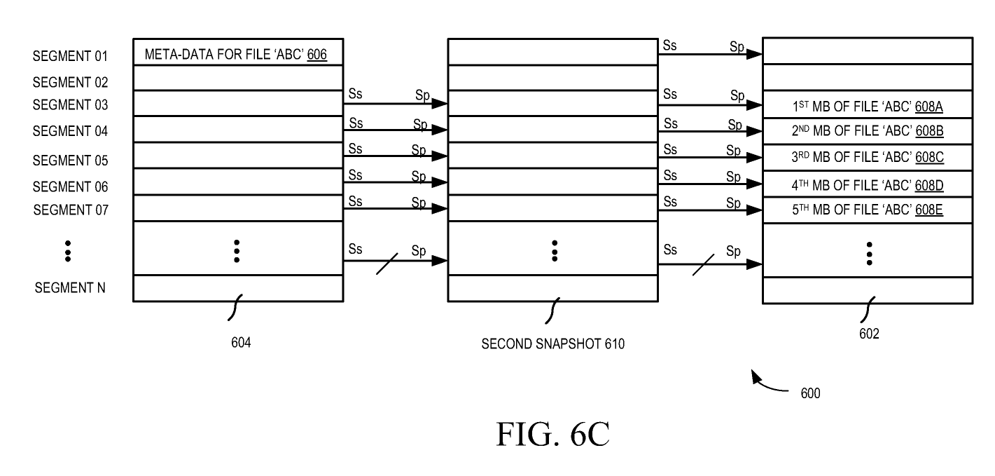

In one embodiment, a data validity bit of the snapshot allocated for a logical segment may be set (1‘’) when a corresponding flag bit in the normalized file-system data bitmap 508 is configured clear (‘0’) and a corresponding successor share bit of the predecessor snapshot allocated for the logical segment is configured as ‘1’. That is, although the block(s) in the file-system data appears to contain free space, the predecessor snapshot being set may indicate that there is sharing relationship between the current snapshot and its predecessor. So, the logical segment may be concluded to contain data other than free or unused space. This may be the case when valid data stored in the logical segment of the predecessor snapshot is deleted prior to the formation of the snapshot, as will be illustrated in details in FIGS. 6A-6C. Since the snapshot for the logical segment contains data other than free space, each share bit of the snapshot for the logical segment may be set (‘1’) as in the case of logical segment 3 in the sharing bitmap of the snapshot 520.

As illustrated in the schematic diagram 500, if a data validity bit for a snapshot of a logical segment is clear (‘0’), then the successor bit for the snapshot of the logical segment is also cleared. Additionally, the predecessor bit in the successor allocated for the logical segment may be cleared. This may ensure that no disk space may need to be allocated for any logical segment that contains invalid data.

FIGS. 6A-6C illustrate schematic diagrams of an exemplary process 600 for maintaining data consistency of logical segments in the logical disks, according to one embodiment. The process 600 may be implemented to deal with the case where valid data stored in the predecessor of a logical segment is deleted prior to the formation of the current snapshot of the logical segment. In this case, it may not be enough to configure share bits of the current snapshot of the logical segment based on the validity of the current snapshot of the logical segment. To configure the share bits, sharing relationship between the predecessor and the current snapshot may need to be checked as well.

In FIG. 6A, all the segments that contain ‘allocated’ blocks of a file system are shared between a logical disk 602 and a first snapshot 604 or its predecessor, where their respective data validity bits and share bits are set accordingly. Conversely, those logical segments that contain ‘unallocated’ or free space blocks are unshared, where their respective share bits and data validity bits are cleared. Each arrow in the figure represents a sharing relationship between the predecessor, which is the first snapshot 604, and a successor, which is the logical disk 602, for each segment. Thus, logical segments 1, 3, 4, 5, 6, and 7 have sharing relationship between the first snapshot 604 and the logical disk 602. Conversely, logical segments 2 and N are shown as not having sharing relationship between the first snapshot 604 and the logical disk 602.

In FIG. 6B, when meta-data for file ‘ABC’ 606 in logical segment 01 is deleted at some time after the generation of the first snapshot 604, the content or data stored in logical segment 01 is physically copied to the first snapshot first. This is to ensure that the first snapshot 604 retains the currently deleted meta-data for file ‘ABC’ 606 as it was at the time of the creation of the first snapshot 604. It is noted that this process is known to a person skilled in the art as ‘copy before write’ (CBW) process, where the deletion may be another form of writing in this case. During the CBW process, one or more physical segments which correspond to the size of logical segment 01 may be created for the first snapshot 604 to make a space to copy the data from logical segment 01 of the logical disk 602 to the first snapshot 604. Once this is done, logical segment 01 in the logical disk 602 may be updated to effect the file delete operation. Then, logical segment 01 may be “unshared” between the first snapshot 604 and the logical disk 602, as the arrow is removed. Additionally, file-system meta-data for actual data described by the meta-data for file ‘ABC’ 606 may be marked as ‘free’ or ‘invalid.’ This may result since the deletion of a file in a file system involves the deletion of the meta-data of the file rather than the actual data stored in the file. For example, in Linux® ext2 file-system, the data blocks corresponding to 5 megabyte (MB) data for file ‘ABC’ may be marked as “cleared” in the block bitmap. However, it should be noted that, the actual 5 MB data may not be directly updated in any way.

In FIG. 6C, data validity bits for logical segments 03, 04, 05, 06, and 07 for a second snapshot 610 may be cleared since the meta-data describing file ‘ABC’ or logical segments 01-07 is marked as ‘free’ or ‘invalid.’ However, share bits in the second snapshot 610 representing logical segments 03 through 07 may not be cleared since there is a sharing relationship between the first snapshot 604 (predecessor) and the logical disk 602 before the second snapshot 610 (current snapshot) is created. Accordingly, the second snapshot 610 continues to inherit that sharing relationship from its predecessor. Thus, for logical segments 03 through 07, these segments may be indicated as “free/unallocated” by the file-system that resides on the logical disk 602, but the segments may still need to be marked as “shared.” Hence, share bits for these segments in the second snapshot 610 may not be cleared.

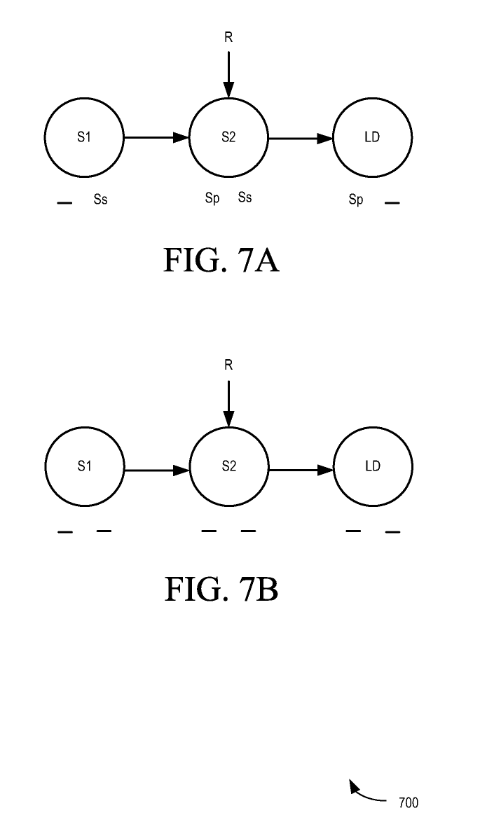

FIGS. 7A and 7B illustrate schematic diagrams 700 of exemplary read operations directed to a snapshot, according to one embodiment. In one embodiment, when a read operation is directed to a snapshot of a logical segment and the corresponding data validity bit of the snapshot of the logical segment is set, it is first checked whether the successor sharing bit of the snapshot of the logical segment is clear. This may be the case where there is no successor to this snapshot with respect to the logical segment, and where the snapshot of the logical segment stores valid data. If it is the case, then the read operation is performed on one or more physical segments allocated for the logical segment. Otherwise, the successors to the snapshot may be traversed until a particular successor with its successor share bit cleared is encountered. Then, the read operation may be performed on the physical segments (PSEGS) which correspond to the logical segment and located in the PSEG allocation map for the successor. This may be the case where there is at least one successor to this snapshot with respect to the logical segment, and where the snapshot of the logical segment stores valid data. For example, in FIG. 7A, if a read operation (R) is directed to second snapshot (S2) of a logical segment, the read operation may be performed on one or more physical segments in logical disk (LD) which corresponds to the logical segment.

In another embodiment, when a read operation is directed to a snapshot of a logical segment and a corresponding data validity bit of the snapshot of the logical segment is clear, then zero-filled buffer may be returned. This may be the case where the snapshot of the logical segment contains invalid data or free space. For example, in FIG. 7B, if a read operation (R) is directed to S2 of a logical segment, the read operation may be skipped, thus saving time, as the S2 of the logical segment is known to contain invalid data.

FIGS. 8A-8C illustrate schematic diagrams 800 of exemplary write operations directed to a snapshot, according to one embodiment. In FIG. 8A, a write operation (W) may be initiated to a second snapshot (S2) of a logical segment. In one embodiment, if a data validity bit for S2 of the logical segment is set, a CBW may be performed to a first snapshot (S1) and to S2 as in FIG. 8B. It is noted that the CBW to S1 may be performed to ensure that S1 retains data of the logical segment as it was at the time of the generation of S1 by copying the data from its logical disk (LD) before any change in S2, with which S1 is sharing the data of the logical segment, due to the write operation (W). It is further noted that the CBW to S2 may be performed to ensure that S2 retains data of the logical segment as it was at the time of the generation of S2 by copying the data from its logical disk (LD) before any change in S2 due to the write operation (W). This way, S2 can build on the data stored in the logical segment with the write operation (W). During each CBW operation, one or more physical segments which correspond to the logical segment may be assigned to each snapshot. Then, content in the logical segment of the LD may be copied to the physical segments allocated for each snapshot. Then, the write operation (W) may be performed on the second snapshot of the logical segment. Subsequently, share bits of the snapshots and the logical disk may be cleared.

In another embodiment, if a data validity bit for S2 of the logical segment is clear, a CBW may be performed to S1 and S2 in FIG. 8B. During each CBW operation, no physical segment may be allocated for the logical segment since the logical segment does not contain valid data. This may reduce time and space necessary for allocation of physical segments for the invalid data during each CBW operation. Then, one or more physical segments may be allocated for the second snapshot of the logical segment, and this may be reflected in the physical segment allocation map. Additionally, the allocation bit (A-bit) for the physical segments may be set. Then, in FIG. 8C, the write operation (W) to S2 may be performed on the physical segments, and the data validity bit for the second snapshot of the logical segment may be set upon a success of the write operation (W). Subsequently, share bits of the snapshots and the logical disk may be cleared.

FIGS. 9A-9C illustrate schematic diagrams 900 of an exemplary snapclone operation, according to one embodiment. In FIG. 9A, S1 has a sharing relationship with LD. In FIG. 9B, upon a receipt of a snapclone operation, a snapclone (C1) may be created, where the creation of C1 thus far may not be different from the creation of S2. Then, in FIG. 9C, a background copy (BG copy) operation is performed on the snapclone. During the BG copy operation, physical segments which correspond to logical segments of LD are allocated, and the file-system data in LD are copied to the physical segments.

In one embodiment, during the snapclone operation, those logical segments that have valid data, as indicated by their data validity bits being set (to ‘1’) may be copied from LDs. In other words, other logical segments that have invalid data or free space, as indicated by their validity bits being clear (‘0’) may be skipped during the BG copy operation. This way, a minimal amount of the physical disk space, for example physical segments, or time may be allocated for the snapclone operation.

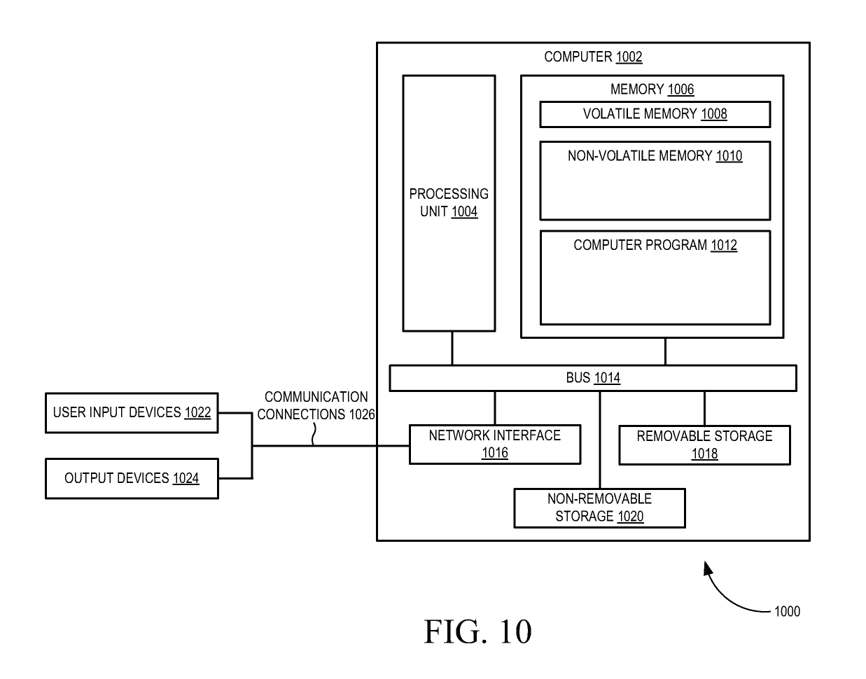

FIG. 10 shows an example of a suitable computing system environment 1000 for implementing embodiments of the present subject matter. FIG. 10 and the following discussion are intended to provide a brief, general description of a suitable computing environment in which certain embodiments of the inventive concepts contained herein may be implemented.

A general computing device, in the form of a computer 1002, may include a processing unit 1004, a memory 1006, a removable storage 1018, and a non-removable storage 1020. The computer 1002 additionally includes a bus 1014 and a network interface 1016. The computer 1002 may include or have access to a computing environment that includes one or more user input devices 1022, one or more output devices 1024, and one or more communication connections 1026 such as a network interface card or a universal serial bus connection.

The one or more user input devices 1022 may be a digitizer screen and a stylus and the like. The one or more output devices 1024 may be a display device of computer, a computer monitor, and the like. The computer 1002 may operate in a networked environment using the communication connection 1026 to connect to one or more remote computers. A remote computer may include a personal computer, a server, a work station, a router, a network personal computer, a peer device or other network nodes, and/or the like. The communication connection 1026 may include a local area network, a wide area network, and/or other networks.

The memory 1006 may include a volatile memory 1008 and a non-volatile memory 1010. A variety of computer-readable media may be stored in and accessed from the memory elements of the computer 1002, such as the volatile memory 1008 and the non-volatile memory 1010, the removable storage 1018 and the non-removable storage 1020. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processing unit 1004, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 1004 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, and the like, for performing tasks, or defining abstract data types or low-level hardware contexts.

Machine-readable instructions stored on any of the above-mentioned storage media may be executable by the processing unit 1004 of the computer 1002. For example, a computer program 1012 may include machine-readable instructions capable of generating a snapshot of one or more logical disks storing file-system data according to the teachings and herein described embodiments of the present subject matter. In one embodiment, the computer program 1012 may be included on a CD-ROM and loaded from the CD-ROM to a hard drive in the non-volatile memory 1010. The machine-readable instructions may cause the computer 1002 to encode according to the various embodiments of the present subject matter.

For example, the computer-readable medium for generating a snapshot of one or more logical disks storing file-system data associated with a file system has instructions. The instructions, when executed by the computer 1002, may cause the computer to perform a method, in which the file system may be frozen upon a receipt of a command to generate the snapshot of the logical disks, where the snapshot is a copy of the logical disks at a point in time. Then, a disk usage of the logical disks at the point in time may be determined. Further, a sharing bitmap associated with the snapshot may be generated based on the disk usage, where the sharing bitmap is configured to indicate sharing of the file-system data with the logical disks and a predecessor snapshot immediately preceding the snapshot. Then, the file system may be turned on again. The operation of the computer 1002 for generating a snapshot of logical disks storing file-system data is explained in greater detail with reference to FIGS. 1 through 10.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method of a file system for generating a snapshot of at least one logical disk storing file-system data, comprising:
quiescing the file system upon a receipt of a command to generate the snapshot of the at least one logical disk, wherein the snapshot is a copy of the at least one logical disk at a point in time;
determining a disk usage of the at least one logical disk at the point in time;
generating a sharing bitmap associated with the snapshot based on the disk usage, wherein the sharing bitmap is configured to indicate sharing of the file-system data with the at least one logical disk and a predecessor snapshot immediately preceding the snapshot; and
unquiescing the file system.

2. The method of claim 1, wherein the determining the disk usage comprises:
generating a file-system data bitmap comprising a plurality of flag bits, wherein a number of the plurality of flag bits is equal to a number of blocks in the file-system data;
initializing the file-system data bitmap by assigning ‘0’s to the plurality of flag bits; and
configuring the plurality of flag bits in the file-system data bitmap based on file-system meta-data associated with the at least one logical disk and configured to indicate validity of the file-system data, wherein a flag bit is set to ‘1’ if a corresponding block stores valid data or remains clear if the corresponding block contains free-space.

3. The method of claim 2, further comprising normalizing a granularity of the file-system data bitmap to a granularity of the sharing bitmap to generate a normalized file-system data bitmap, wherein the granularity of the file-system data bitmap is determined by each block which correspond to said each flag bit in the file-system data bitmap, and wherein the granularity of the sharing bitmap is determined by a size of each logical block in the at least one logical disk.

4. The method of claim 3, further comprising:
forming a data validity bitmap comprising a set of data validity bits, wherein the set of data validity bits are equal in number with logical segments of the at least one logical disk;
initializing the data validity bitmap by assigning ‘0’s to the set of data validity bits; and
configuring the data validity bitmap based on the normalized file-system data bitmap and a sharing bitmap of the predecessor snapshot.

5. The method of claim 4, wherein the configuring the data validity bitmap comprises assigning ‘1’ to a data validity bit of the snapshot allocated for a logical segment of the at least one logical disk when a flag bit in the normalized file-system data bitmap which corresponds to the logical segment is configured as ‘1’.

6. The method of claim 4, wherein the configuring the data validity bitmap comprises assigning ‘0’ to a data validity bit of the snapshot allocated for a logical segment of the at least one logical disk when a flag bit in the normalized file-system data bitmap which corresponds to the logical segment is configured as ‘0’ and a successor share bit of the predecessor snapshot allocated for the logical segment is configured as ‘0’.

7. The method of claim 4, wherein the configuring the data validity bitmap comprises assigning ‘1’ to a data validity bit of the snapshot allocated for a logical segment of the at least one logical disk when a flag bit in the normalized file-system data bitmap which corresponds to the logical segment is configured as ‘0’ and when a successor share bit of the predecessor snapshot allocated for the logical segment is set.

8. The method of claim 6, wherein the generating the sharing bitmap comprises:
clearing a successor share bit of the snapshot in the sharing bitmap for the logical segment; and
clearing a predecessor share bit of a successor logical disk to the snapshot.

9. The method of claim 6, further comprising:
receiving a command for a read operation of the snapshot of the logical segment; and
returning a zero-filled buffer.

10. The method of claim 6, further comprising:
receiving a command for a write operation to the snapshot which correspond to the logical segment of the at least one logical disk;
allocating at least one physical segment to the snapshot which corresponds to the logical segment if there is no physical segment allocated to the logical segment;
performing the write operation to the at least one physical segment; and
setting the data validity bit.

11. The method of claim 6, further comprising generating a snapclone of the at least one logical disk by performing a background copy of the at least one logical disk to the snapshot, wherein the background copy of the at least one logical disk comprises skipping a duplication of the logical segment to the snapshot.

12. The method of claim 7, further comprising:
receiving a command for a read operation of the snapshot of the logical segment;
checking whether a successor share bit of the snapshot is clear; and
if the successor share bit of the snapshot is clear, reading and returning content of at least one physical segment allocated for the snapshot of the logical segment; or if the successor share bit of the snapshot is set, traversing at least one successor of the snapshot of the logical segment until encountering a particular successor of the snapshot with its successor share bit clear and reading and returning content of at least one physical segment allocated for the particular successor of the logical segment.

13. The method of claim 7, further comprising:
receiving a command for a write operation to the snapshot which correspond to the logical segment of the at least one logical disk;
performing a copy before write operation to the predecessor snapshot and to the snapshot of the logical segment; and
performing the write operation to the snapshot of the logical segment.

14. A file server for generating a snapshot of at least one logical disk containing file-system data, comprising:
a processor; and
a memory configured for storing a set of instructions for generating a snapshot of at least one logical disk containing file-system data, when executed by the processor, causes the processor to perform a method comprising:
quiescing the file system upon a receipt of a command to generate the snapshot of the at least one logical disk, wherein the snapshot is a copy of the at least one logical disk at a point in time;
determining a disk usage of the at least one logical disk at the point in time;
generating a sharing bitmap associated with the snapshot based on the disk usage, wherein the sharing bitmap is configured to indicate sharing of the file-system data with the at least one logical disk and a predecessor snapshot immediately preceding the snapshot; and
unquiescing the file system.

15. A computer readable medium for generating a snapshot of at least one logical disk containing file-system data associated with a file system having instructions that, when executed by the computer, cause the computer to perform a method comprising:
quiescing the file system upon a receipt of a command to generate the snapshot of the at least one logical disk, wherein the snapshot is a copy of the at least one logical disk at a point in time;
determining a disk usage of the at least one logical disk at the point in time;
generating a sharing bitmap associated with the snapshot based on the disk usage, wherein the sharing bitmap is configured to indicate sharing of the file-system data with the at least one logical disk and a predecessor snapshot immediately preceding the snapshot; and
unquiescing the file system.
